(19) United States
(12) Patent Application Publication
(10) Pub. No.: US 2025/0071353 A1
(43) Pub. Date: Feb. 27, 2025

(54) Advertisement Supported Video Download

(71) Applicant: Comcast Cable Communications, LLC, Philadelphia, PA (US)

(72) Inventor: Michael A. Chen, Wallingford, PA (US)

(21) Appl. No.: 18/944,732

(22) Filed: Nov. 12, 2024

Related U.S. Application Data
(63) Continuation of application No. 17/691,326, filed on Mar. 10, 2022.
Application No. 17/691,326 is a continuation of application No. 17/025,742, filed on Sep. 18, 2020, now Pat. No. 11,310,542.
Application No. 17/025,742 is a continuation of application No. 15/206,586, filed on Jul. 11, 2016, now Pat. No. 10,785,507.
Application No. 15/206,586 is a continuation of application No. 11/733,876, filed on Apr. 11, 2007, now Pat. No. 9,424,587.

(51) Int. Cl. H04N 21/234; G06Q 30/0241; G06Q 30/0251; H04N 5/262; H04N 13/139; H04N 19/57; H04N 19/59; H04N 21/2547; H04N 21/485; H04N 21/488; H04N 21/81

(52) U.S. Cl. CPC H04N 21/23424; G06Q 30/0251; G06Q 30/0276; H04N 13/139; H04N 19/57; H04N 19/59; H04N 21/2547; H04N 21/4858; H04N 21/4886; H04N 21/812; H04N 5/2628; H04N 2201/3226

(57) ABSTRACT

Systems and methods for facilitating advertisements within viewed content. The advertisements may be banner advertisements or other advertisements. The advertisements may be obtained based on a request for an advertisement for insertion into an opportunity for inserting an advertisement in content. The advertisement may additionally or alternatively be obtained based on a Universal Resource Locator associated with the advertisement.

### CROSS-REFERENCE TO RELATED APPLICATION

This application is a continuation of U.S. application Ser. No. 17/691,326, filed Mar. 10, 2022, which is a continuation of U.S. application Ser. No. 17/025,742, filed Sep. 18, 2020, now U.S. Pat. No. 11,310,542, which is a continuation of U.S. application Ser. No. 15/206,586, filed Jul. 11, 2016, now U.S. Pat. No. 10,785,507, which is a continuation of U.S. application Ser. No. 11/733,876, filed Apr. 11, 2007, now U.S. Pat. No. 9,424,587, each of which is incorporated by reference herein in its entirety.

### FIELD OF THE INVENTION

The present invention relates to advertisement supported video downloading of the type wherein advertisements are included with downloaded video.

### BACKGROUND ART

Videos generally comprise a number images embodied in a number of full-frame video frames. The video frames may be displayed over time to view the images included on the various video frames. With respect to broadcast television, for example, advertisements may be included within the video, such as but not limited to supporting costs and other expenses associated with broadcasting the video.

The advertisements may be full-frame advertisements in that they occupy full video frames in a similar manner as the images associated with the watched content. When a viewer watches the video, the images are not shown while the advertisement is being shown due to the corresponding images being full-frame images occupying the entire viewing area.

A portion of the content/image related frames may be interrupted with a number of advertisement frames in a process generally referred to as advertisement splicing. The splicing generally corresponds with the advertisement related video frames being inserted between successive image or non-advertisement frames such that the advertisement frames must be viewed before returning to viewing of the images frames.

One problem with this approach, which is particularly detrimental to the advertisers paying for the corresponding advertisements, occurs when viewers watch the video in a non-real time or non-broadcast manner, such as but not limited to viewing from a video recorder, PC, etc., and fast forwards past, skips, or otherwise limits viewing of the advertisement frames.

### BRIEF DESCRIPTION OF THE DRAWINGS

The present invention is pointed out with particularity in the appended claims. However, other features of the present invention will become more apparent and the present invention will be best understood by referring to the following detailed description in conjunction with the accompany drawing in which:

FIG. 1 illustrates a system for advertisement supported video delivery in accordance with one non-limiting aspect of the present invention;

FIG. 2 illustrates a video frame in accordance with one non-limiting aspect of the present invention; and

FIG. 3 illustrates a flowchart of a method of advertisement supported video download in accordance with one non-limiting aspect of the present invention.

### DETAILED DESCRIPTION OF THE PREFERRED EMBODIMENT(S)

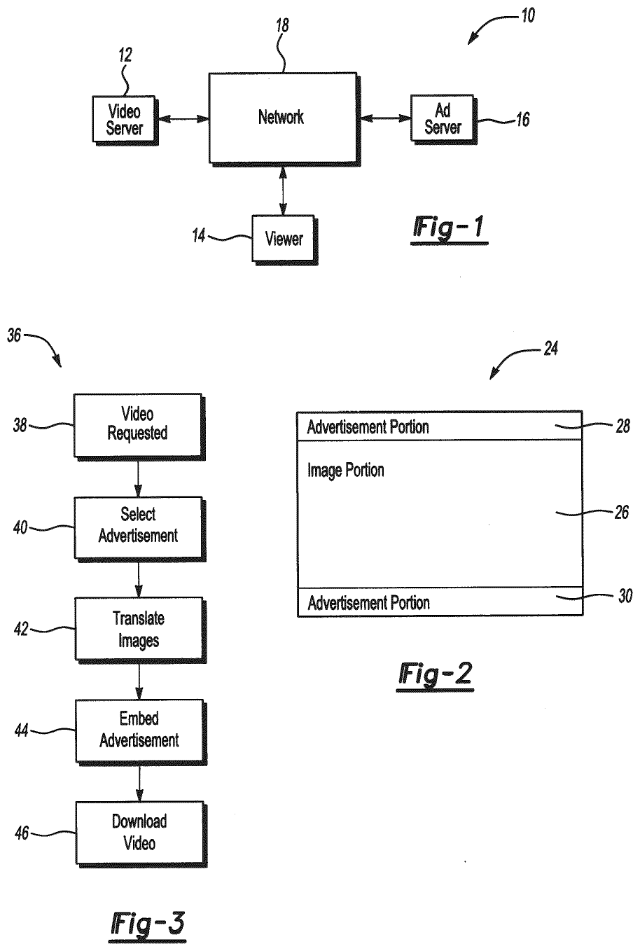

FIG. 1 illustrates a system 10 for advertisement supported video delivery in accordance with one non-limiting aspect of the present invention. The system 10 may generally correspond with downloading, or otherwise communicating, a video, or other content file, from a video server 12 to a viewer 14 for viewing. The viewer may be a television, computer, digital video recorder, mobile device, and/or other entity configured to support playback of the video.

The system 10 may further include an advertisement server 16 to provide advertisements for inclusion within the video. The advertisement server 16, video server 12, and viewer 14 may be connected to each other or otherwise in communication by way of a network 18. The network 18 may comprise any wireline and/or wireless network sufficient to support electronic communications between the same. The videos and advertisements may be communicated over the network 18 to provide advertisement support video delivery in accordance with one non-limiting aspect of the present invention.

The present invention, as noted below, is predominately described with respect to downloading a video file or other length of video to a computer or mobile device for subsequent playback. The video may be download to any device suitable to facilitate video playback, such as but not limited to those devices having capabilities to support fast forward and other video related playback controls. While the present invention is described in this manner, it is not intended to be so limited and fully contemplates its application to other environments and supporting advertising in any type of video viewing, including but not limited cable television on-demand and broadcast (real-time) related viewing.

The types of devices having capabilities to support fast forward and other related video controls provide problems with respect to requiring or otherwise forcing advertisement viewing, as the operators thereof may elect to fast forward or otherwise skip the advertisement. One non-limiting aspect of the present invention is intended to limit this problem by requiring any fast forwarding or skipping of the advertisement to correspond with fast forwarding or skipping a corresponding portion of the video, i.e., the content desired for viewing, on the belief that viewers will be less likely to fast forward or otherwise skip the advertisement if the corresponding content must also be fast forwarded or otherwise skipped.

The video may comprise or otherwise be made up on a number of images included on a number of video frames. The corresponding image frames may be played in succession by the viewer 14 or other device to facilitate viewing of the corresponding images/content. The video frames may be associated with analog or digital communication methodologies and transferred according to any number of protocols and standards associated with the same. The video delivered to the viewer 14 may be received from a video source remotely located from the video and it may include full-frame images designed to provide full screen viewing for standard (4×3), widescreen (16×9), or other viewing screens.

The advertisement server 16 may include any number and type of advertisements for inclusion within the video. The advertisements may be full-frame and/or limited frame video and/or non-video advertisements. Optionally, the advertisements may be banner advertisement, such as the type commonly known to appear on websites or webpages, such as the type that appear across a portion of a webpage. The banner advertisement may include an image, video, or other animation, as well as a link to a webpage or other resource associated with an advertiser.

Banner advertisements are commonly employed on websites to facilitate generation of advertisement revenue. When a user views the website, the banner advertisements appear to convey a message, image, or other feature, and optionally a link or other means for directing the viewer to a website associated with the advertisers. Advertisements servers, such as the one shown in FIG. 1, may be employed to support selection and delivery of such banner advertisements.

Advertisers desiring to pay for or otherwise purchase advertisements may upload a picture and URL address to the server. The server 16 may format the picture (or other image) and process the URL to provide a banner advertisement of desired size, shape, appearance, etc.

The advertiser may be required to pay varying amounts for these features as well as for each showing of the advertisement. One non-limiting aspect of the present invention contemplates including such banner advertisements within downloaded video and charging the corresponding advertisers for each showing of the banner advertisements so as to support advertisement-based video download.

The video server 12 may be configured to receive a particular video for downloading to the viewer 14. The request may include information on the viewer 14 and/or otherwise be associated with the same. This information may then be provided to the advertisement server 16 to facilitate selecting one or more advertisements for inclusion within the video. The advertisers and/or advertisement server 16 may specify any number of conditions and/or algorithms to support selecting the advertisements. The selected advertisements may be sent to the video server 12 and included within the video download.

The video server 12 may be configured to embed the advertisements within the video such that the viewer is unable to fast forward or otherwise skip the advertisement without fast forwarding or otherwise skipping at least a portion of the video. This may include embedding the advertisements within the image frames comprising the video such that the corresponding video frames include images and advertisements on the same frame such that if the user skips the frame, the corresponding image must also be skipped.

The advertisement may be included and/or otherwise embedded within the video frames according to any suitable methodology, which may depend on the type of advertisement, i.e., whether the advertisement is a banner advertisement or a video advertisement. Any suitable tracking system may be used to track advertisement inclusion and whether the included advertisement were actually accessed by the viewer 14, i.e., whether the user clicked on the advertisement.

The embedding of the advertisements may optionally include translating the images to occupy a smaller portion of the video frames. Full-frame images, for example, may be sized to take up the entire viewing area of the screen or other device used to view the video. The present invention, however, contemplates reducing the image size, such as through a translation process, so that the corresponding image occupies a smaller portion, something less than full-frame. This creates a gap/available area for inclusion within the video frame, which the present invention contemplates for receipt of the advertisement.

The gap produced from translating the images may correspond with a pillar box and/or letter box. The pillar box may correspond with a portion of a standard viewing area (4×3) and the letter box may correspond with a portion of a widescreen viewing area (16×9). The boxes may be arranged on the top, bottom, or side of the images to provide space for the advertisements. Another methodology to create room for the advertisement may include converting standard full-frame images to widescreen images, the widescreen images being wider and shorter than the standard images, thereby creating a suitable gap above and below the image.

The size of the gap may also be suited or adjusted to the size of the selected advertisement. Optionally, rather than relying on gaps, the advertisement may be overlaid used to block out or cover a portion of the image. Once the positioning, sizing, and other aspect related to advertisement are determined, optionally by the video server 12, the advertisement may be embedded into the corresponding video frame such that the video frame now includes and image portion and an advertisement portion.

FIG. 2 illustrates a video frame 24 having image 26 and advertisement portions 28-30 in accordance with one non-limiting aspect of the present invention. The illustration generally corresponds with advertisement portions 28-30 being provided relative to a top and bottom side of the image portion 26. The advertisement portions 28-30, however, may be located at any position relative to the image portion 26, and optionally, depending to the translation of the image. Furthermore, if the multiple advertisement portions are included, different advertisements may be included in each portion. The advertisements may be changed over time, and during playback of the same video.

If the viewing device includes other processing and communication capabilities, the advertisements may be clicked on or otherwise selected to access more information with respect to the associated advertisement, such as by being transported to website of the advertiser if such an address is included within or otherwise associated with the advertisement. Optionally, if the advertisements are banner advertisements, i.e., internet based advertisements having images and URLs, such advertisements may still be included even if the viewer is unable to access the corresponding website, such as to facilitate displaying a logo of the advertiser.

FIG. 3 illustrates a flowchart 36 of a method of advertisement supported video download in accordance with one non-limiting aspect of the present invention. The method broadly relates to including advertisements within video. The method is describe with respect to a file download or other process wherein a user obtains a full copy of the video for playback when not connected or in communication with a video server from which the video may be downloaded. This is done for exemplary purposes only and the present invention fully contemplates its application to any process for providing video.

Block 38 relates to receipt of a video request. The video request may be made from a viewer to a video server and specify a video or other content desired for downloading. User information, device information, and other information may be determined from the request to identify the video, the capabilities of the device intended to playback the video, interests/habits of the user, etc. This information may be communicated to an advertisement server and/or used by the video server in facilitating the video download.

Block 40 relates to selecting an advertisement for inclusion with the video download. The selected advertisement may be determined by the video or advertisement server. It may be selected to correspond with the user's viewing habits and/or capabilities of the device intended to playback the downloaded video. Optionally, advertisers may specify how their advertisements may be selected and the advertisers may be billed upon the selection thereof.

Block 42 relates to optionally translating images associated with the video to make room or gaps of the selected advertisements. One or more images associated with one or more frames may be translated in this manner. Some video frames may include different sized image translation relative to other video frames depending on the size and shape of the advertisement intended for the same, such as if different advertisements are selected for showing at different times and/or within the same video frame.

Block 44 relates to embedding the advertisement in at least a portion of a number of video frames making up the requested video. The video frames may be adapted to include images associated with the requested video and the selected advertisement such that at least a portion of the video frames include banner advertisements and images. This may be helpful in preventing fast forwarding past the banner advertisements without similarly fast forwarding past a corresponding portion of the images

Block 46 relates to downloading the requested video, including the embedded advertisements, to the viewer. The video may be downloaded in any suitable manner. Once downloaded, the video providing entity and advertisers may gain a mutual benefit in requiring playback of the video to automatically include viewing of the embedded advertisements, unless of course the advertising portion of the video is fast forwarded or otherwise skipped, which may be unlikely considering such action will fast forward past or skip a corresponding portion of the video do to the images being on some of the same frames as the advertisements.

As described above, one non-limiting aspect of the present invention may relate to collecting online banner ad images and injecting/encoding them into video content such that the banner ad images are present while the video content is being played back. This allows an advertising-supported model for offering video content, such as but not limited for use with portable media devices, video on demand (VOD), online streaming, etc.

The online banner ads may be collected e.g. from a URL, and a script may be constructed to govern their injection/encoding into video content using image composition techniques e.g. scaling and translation. One embodiment may select the banner ads to associate with a piece of video content based on some correlation/correspondence between known, deduced or derived properties of the video content and known, deduced or derived properties of the selected advertisements. E.g., if the video content is discovered to be basketball, the advertising can steer toward NBA, WNBA, basketball apparel and/or footwear, related professional sports, etc.

One non-limiting aspect of the present invention relates to providing methods for advertising support for a free video download content model to portable devices. This technique may inhibit separation of advertising from main content in by compositing the ads and the content in the same video frame. Since the online banner ads can be tracked via the download URL, and the portable media content can be tracked via content file download, an ad-sponsored free content business model is facilitated.

As required, detailed embodiments of the present invention are disclosed herein; however, it is to be understood that the disclosed embodiments are merely exemplary of the invention that may be embodied in various and alternative forms. The figures are not necessarily to scale; some features may be exaggerated or minimized to show details of particular components. Therefore, specific structural and functional details disclosed herein are not to be interpreted as limiting, but merely as a representative basis for the claims and/or as a representative basis for teaching one skilled in the art to variously employ the present invention.

While embodiments of the invention have been illustrated and described, it is not intended that these embodiments illustrate and describe all possible forms of the invention. Rather, the words used in the specification are words of description rather than limitation, and it is understood that various changes may be made without departing from the spirit and scope of the invention.

What is claimed is:

1. A method comprising:
determining, by a computing device, an opportunity for inserting an advertisement in content;
sending, to an advertisement server via a network, a request for an advertisement for insertion into the opportunity for inserting an advertisement in the content, wherein the request comprises information for selection of the advertisement;
receiving a response indicating an advertisement selected based on the request; and
causing output of the advertisement during the opportunity for inserting the advertisement in the content.

2. The method of claim 1, wherein the content comprises one or more of:
broadcast content;
streaming content;
video-on-demand content; or
downloaded content.

3. The method of claim 1, wherein the computing device comprises a content server, the method further comprising:
receiving the advertisement via a second network.

4. The method of claim 1, wherein the computing device comprises a content server, and wherein the receiving the response comprises receiving the response from the advertisement server, the method further comprising:
inserting the advertisement into the content.

5. The method of claim 1, further comprising:
obtaining the advertisement via a Universal Resource Locater (URL) address for the advertisement.

6. The method of claim 1, further comprising:
tracking one or more interactions, of a user, associated with the advertisement.

7. The method of claim 1, wherein the network comprises the Internet, the method further comprising:
receiving, via the Internet, the advertisement.

8. The method of claim 1, wherein causing the output comprises causing output, via a device associated with a user, of the advertisement during the opportunity for inserting the advertisement, and wherein the information for selection of the advertisement indicates one or more of:
one or more capabilities of the device associated with the user;
one or more properties of the content;
subject matter of the content;
one or more habits of the user; or
one or more interests of the user.

9. A method comprising:
determining, by a computing device, an opportunity for inserting an advertisement in content;
sending, to an advertisement server via a network, a request for an advertisement for insertion into the opportunity for inserting an advertisement in the content, wherein the request comprises information for selection of the advertisement;
obtaining, based on the request, an advertisement via a Universal Resource Locator (URL) address; and
causing output of the advertisement during the opportunity for inserting the advertisement in the content.

10. The method of claim 9, wherein the content comprises one or more of:
broadcast content;
streaming content;
video-on-demand content; or
downloaded content.

11. The method of claim 9, wherein the computing device comprises a content server, and wherein the obtaining the advertisement comprises obtaining the advertisement by accessing the URL address via a second network.

12. The method of claim 9, wherein the causing output of the advertisement comprises sending, by the computing device, the advertisement inserted in the opportunity for inserting the advertisement in the content.

13. The method of claim 9, wherein causing the output comprises causing output of the advertisement via a device associated with a user, during the opportunity for inserting the advertisement, and wherein the information for selection of the advertisement indicates one or more of:
one or more capabilities of the device associated with the user;
one or more properties of the content;
one or more habits of the user; or
one or more interests of the user.

14. An apparatus comprising:
one or more processors; and
memory storing instructions that, when executed by the one or more processors, configure the apparatus to:
determine an opportunity for inserting an advertisement in content;
send, to an advertisement server via a network, a request for an advertisement for insertion into the opportunity for inserting an advertisement in the content, wherein the request comprises information for selection of the advertisement;
receive a response indicating an advertisement selected based on the request; and
cause output of the advertisement during the opportunity for inserting the advertisement in the content.

15. The apparatus of claim 14, wherein the content comprises one or more of:
broadcast content;
streaming content;
video-on-demand content; or
downloaded content.

16. The apparatus of claim 14, wherein the instructions, when executed by the one or more processors, further configure the apparatus to:
receive the advertisement via a second network.

17. The apparatus of claim 14, wherein the instructions, when executed by the one or more processors, further configure the apparatus to:
insert the advertisement into the content.

18. The apparatus of claim 14, wherein the instructions, when executed by the one or more processors, further configure the apparatus to:
obtain the advertisement via a Universal Resource Locater (URL) address for the advertisement.

19. The apparatus of claim 14, wherein the network comprises the Internet, and wherein the instructions, when executed by the one or more processors, further configure the apparatus to:
receive, via the Internet, the advertisement.

20. The apparatus of claim 14, wherein the instructions, when executed by the one or more processors, configured the apparatus to cause the output by causing output, via a device associated with a user, of the advertisement during the opportunity for inserting the advertisement, and wherein the information for selection of the advertisement indicates one or more of:
one or more capabilities of the device associated with the user;
one or more properties of the content;
subject matter of the content;
one or more habits of the user; or
one or more interests of the user.
